(19) United States
(12) Patent Application Publication
(10) Pub. No.: US 2021/0047077 A1
(43) Pub. Date: Feb. 18, 2021

(54) BOTTLE TAG

(71) Applicant: John Fenwick, Toronto (CA)

(72) Inventor: John Fenwick, Toronto (CA)

(21) Appl. No.: 16/981,736

(22) PCT Filed: Mar. 21, 2019
(86) PCT No.: PCT/CA2019/050346

§ 371 Date: Sep. 17, 2020

(30) Foreign Application Priority Data
Mar. 22, 2018 (CA) 2,998,945

(51) Int. Cl. B65D 23/14; B65D 51/24; G09F 3/02

(52) U.S. Cl. CPC B65D 23/14; B65D 51/245; G09F 2003/0273; G09F 2003/0251; G09F 3/02

(57) ABSTRACT

A tag for a bottle having a neck, wherein the tag comprises a band for engaging the neck of the bottle and a label portion extending from the band. The band frictionally engages the whole circumference of the neck of the bottle in order to maintain the placement of the tag on the exterior surface of the neck of the bottle. The label portion of the tag extends outwardly from the band at an angle with respect to the vertical axis of the bottle neck.

### CROSS-REFERENCE TO RELATED APPLICATIONS

The present application claims the benefit of priority of Canadian Patent no. 2,998,945, filed on Mar. 22, 2018, the contents of which are incorporated herein by reference in their entirety

### FIELD

The present disclosure relates to a bottle tag. In particular, the disclosure relates to a tag for a bottle having a neck, wherein the tag comprises a band for engaging the neck of the bottle and a label portion extending from the band.

### INTRODUCTION

Bottles, such as wine bottles, have necks, from which personalized labels or gift tags are often attached. Such labels may be attached using string, such that the tag hangs over the body of the bottle and covers the wine label. Other personalized labels or gift tags are made of cardboard with a hole for the neck, which also loosely hang over the body and cover the wine bottle's label.

### SUMMARY

The present disclosure relates to a bottle label or gift tag comprising a band which engages the neck of a bottle having a neck, such as a wine bottle, liquor bottle or beer bottle. The bottle label or gift tag also comprises a label extending outwardly from the band. Accordingly, the disclosure includes a tag for a bottle having a neck, the tag comprising:
i) a band which engages the neck of the bottle;
ii) a label which extends outwardly from the circular band.

Other features and advantages of the present application will become apparent from the following detailed description. It should be understood, however, that the detailed description and the specific examples while indicating preferred embodiments of the application are given by way of illustration only, since various changes and modifications within the spirit and scope of the application will become apparent to those skilled in the art from this detailed description.

### BRIEF DESCRIPTION OF THE DRAWINGS

The present disclosure will now be described in greater detail with reference to the drawings in which:

FIG. 1 is a front perspective view of a bottle tag attached to a bottle in one embodiment of the disclosure;

FIG. 2 is a top view of a bottle tag attached to a bottle in one embodiment of the disclosure;

FIG. 3 is a front perspective view of a bottle tag attached to a bottle in another embodiment of the disclosure;

FIG. 4 is a front perspective view of a bottle tag attached to a bottle in a different embodiment of the disclosure.

FIG. 5 is a front perspective view of a bottle tag attached to a bottle in another embodiment of the disclosure;

FIGS. 6A and 6B are front perspective views of a bottle tag having flex vanes.

### DESCRIPTION OF VARIOUS EMBODIMENTS

The present disclosure relates to a bottle label or gift tag for a bottle having a neck, comprising a band which engages the neck of the bottle, such as a wine bottle, liquor bottle or beer bottle. The bottle label or gift tag also comprises a label extending outwardly from the band. Accordingly, the disclosure includes a bottle tag for a bottle having a neck, the tag comprising:
i) a band which engages the neck of the bottle;
ii) a label which extends outwardly from the circular band.

In one embodiment, the bottle is any bottle having a neck, such as a wine bottle, liquor bottle, beer bottle, cooking oil bottle (such as olive oil), water bottles, or pop bottles, or other decorative bottles, made of glass, plastic or any other suitable material. In another embodiment, the bottle is any type of bottle which has a neck portion and a body portion. In some embodiments, the bottle has a shoulder portion between the neck and body. In other embodiments, the bottle gradually increases in circumference from the neck to the body with no apparent shoulder portion.

In one embodiment, the band is a circular band for positioning around the neck of the bottle.

In one embodiment of the disclosure, the label extends outwardly from the circular band and away from the bottle neck at an angle of about 30° to about 150° with respect to the bottle neck. In one embodiment of the disclosure, the label extends outwardly from the circular band and away from the bottle neck at an angle of about 45° to about 135° with respect to the bottle neck. In one embodiment, the label extends outwardly from the circular band at an angle of about 70° to about 120° with respect to the bottle neck. In another embodiment, the label extends outwardly from the circular band at an angle which is substantially perpendicular, or perpendicular to the bottle neck.

In another embodiment, the label extends horizontally, or substantially horizontally, away from the neck of the bottle.

In one embodiment, the label portion extends outwardly away from the neck, wherein the label portion does not touch the shoulder of the bottle.

In other embodiments, the label extends downwardly along the vertical axis of the bottle neck (such that the label does not extend outwardly away from the bottle neck), which allows for the bottle to be stored horizontally without the label interfering with storage. In further embodiments, the label is adjustable from an outward position to a downward position.

In another embodiment, the band is circular and is a ring, for example, a closed continuous ring, which is stretched over the top of the bottle to engage the neck, wherein the circular band has elastic properties. In some embodiments, the circular band is made of any suitable material, for example a polymer, textile, which has the ability to stretch over the top of the bottle and conform to the exterior shape of the bottle neck. In one embodiment, the band and the label portion are made of the same material. In another embodiment, the band and the label portion are made of a single, continuous piece of the same material.

In one embodiment, the band is an elastically deformable band. In one embodiment, the neck of the bottle has an exterior surface, and wherein the elastically deformable band can be positioned over the neck and biases against the exterior surface. In another embodiment, the label portion extends outwardly generally perpendicular to the vertical axis of the neck of the bottle.

In one embodiment, the band engages the neck of the bottle resulting in physical contact of the band (or flex vanes) and the bottle such that there is some, or complete, resistance to movement of the band on the neck when the tag is placed on the neck by the user. In further embodiments, the band frictionally engages the bottle neck, such that the band maintains its location once placed on the neck of the bottle by a user. In other embodiment, once the band is placed over the top of the bottle (for example, the band is stretched over the top of the bottle and onto the neck), the band (for example a circular band) grips the surface of the bottle and maintains the position where it is placed on the neck.

In one embodiment, the band has an interior surface and an exterior surface, and the interior surface is flexible to be positioned over the neck of the bottle. In one embodiment, the interior surface is flexible to frictionally engage the neck of the bottle. In one embodiment, the band is a ring which is stretched over the top of the bottle to engage the neck, wherein the band has elastic properties. In another embodiment, the exterior surface of the band is made of a rigid material, such as a hard plastic or polymer.

In another embodiment, the band has an interior surface which comprises vanes, for example, flexible vanes, which engage the neck of the bottle. In one embodiment, the interior surface comprises 1, 2, 3, 4, 5, 6, 7, 8, 9, or 10, vanes, which extend along the vertical or horizontal axis, preferably vertical, of the band, and engage the surface of the neck of the bottle. In one embodiment, the vanes are flexible and deform when the bottle tag is placed on the neck of the bottle and the flexible vanes are biased against the neck.

In one embodiment, the interior surface of the band, or the entire band, is made of a material which can grip the screw cap of a bottle, and assist the user in unscrewing the cap by providing friction when the band is squeezed against the cap.

In some embodiments, the band is made of a polymer, elastomer, thermoplastic elastomer or thermoset. In further embodiments, the band has a Young's Modulus of less than about 1.0 GPa. In another embodiment, the band is made of natural rubber, polyisoprene, butyl rubber, chloroprene, ethylene propylene diene, fluorocarbon, fluorosilicone, nitrile butadiene, saturated nitrile, silicone rubber, styrene butadiene, or polyurethane. In another embodiment, the band is made of silicon rubber. In another embodiment, the polymer or plastic is recyclable. In one embodiment, the band is made of high-density polyethylene. In one embodiment, the band is made of low-density polyethylene. In one embodiment, the band is made of polypropylene. In one embodiment, the band is made of polyethylene terephthalate. In one embodiment, the band is made of polyvinyl chloride. In one embodiment, the band is made of polystyrene. In another embodiment, the band is made of a shape memory polymer.

In another embodiment, the tag comprising the band and the label portion is made of a cellulosic material, such as cardboard, cardstock, corrugated cardboard, or paper composite. In one embodiment, the tag is made of a cellulosic material and is recyclable. In one embodiment, the band is made of a corrugated or fluted cellulosic material, which expands upon application over the top of the bottle and constricts on the neck to hold its placement upon the neck. In one embodiment, the band comprises a corrugated or fluted cellulosic material which further comprises elastic bands or lines within the material.

In other embodiments of the disclosure, the band has opposing ends, wherein each end has attachment means and the attachment means are connected such that the band engages the neck of the bottle. In a further embodiment, the attachment means is adhesive, hook and loop (Velcro), a button or a snap. In other embodiment, the band comprises a line or string which is tightened so as to engage the band with the neck of the bottle.

In further embodiments, the band has a width of about 0.5 cm to about 10.0 cm, or 1.0 cm to about 5.0 cm, or about 2.0 cm to about 4.0 cm.

In a further embodiment, the label portion comprises any material upon which a user can write, print, or attach a message using ink, pencil, marker, or attaching a sticker to the label portion. In some embodiments, the label portion comprises paper or cardboard, which allows a user to write message on the label portion itself. In other embodiments, the label portion is made of any other material, for example, a polymer, glass, plastic, textile, which allows a user to attach (for example, using adhesive) a label to the label portion. In some embodiments, the label portion is made of the same material as the band. In one embodiment, the label portion is made of a generally resilient material that extends outwardly, generally perpendicular to the vertical axis of the neck of the bottle, and the resilient material maintains the generally perpendicular positioning. In another embodiment, the label portion extends generally horizontally from the vertical axis of the neck bottle, wherein, when the bottle is upright, a person can read the label portion.

In another embodiment, the label portion is defined by a length which extends outwardly and generally perpendicular to the vertical axis of the neck of the bottle. In one embodiment, the length of the label portion is at least 2.0 cm, or at least about 3.0 cm, or at least about 5.0 cm, or at least about 7.0 cm, or at least about 10.0 cm. In another embodiment, the length of the label portion is between about 1.0 cm to about 20.0 cm, or about 2.0 cm to about 15.0 cm, or about 3.0 cm to about 10.0 cm.

In another embodiment, the label portion is also defined by a width which is at least about 0.5 cm, or at least about 1.0 cm, or at least about 2.0 cm. In another embodiment, the width of the label portion is between about 0.5 cm to about 10.0 cm, or about 1.0 cm to about 5.0 cm, or about 2.0 cm to about 4.0 cm.

In another embodiment, the label portion is defined by a thickness which is at least about 0.1 cm, at least about 0.2 cm, or at least about 0.5 cm, or at least about 1.0 cm. In another embodiment, the thickness of the label portion is between about 0.1 cm to about 2.0 cm, or about 0.2 cm to about 1.0 cm, or about 0.5 cm to about 1.0 cm.

In another embodiment, the label portion is any shape desired by a user, such as a rectangle, diamond, circle, flag, square, or triangle.

In one embodiment, the label portion is affixed to the band. In another embodiment, the label portion is detachable from the band, such that the label portion is discarded or recycled, and the band is re-useable.

In another embodiment, the label portion is operable to be moved from a position which is generally perpendicular to the axis of the neck of the bottle to a position which is generally parallel with the axis of the neck of the bottle.

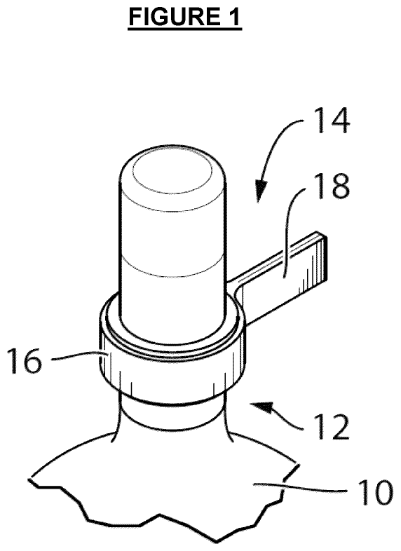

Referring now to the drawings, FIG. 1 shows a bottle 10 having a neck 12 in which a tag 14 of the disclosure has been placed around the neck 12. The tag 14 has a band 16 and a label portion 18 which extends outwardly and away from the neck of the bottle. The band 16 is defined by a width “W”.

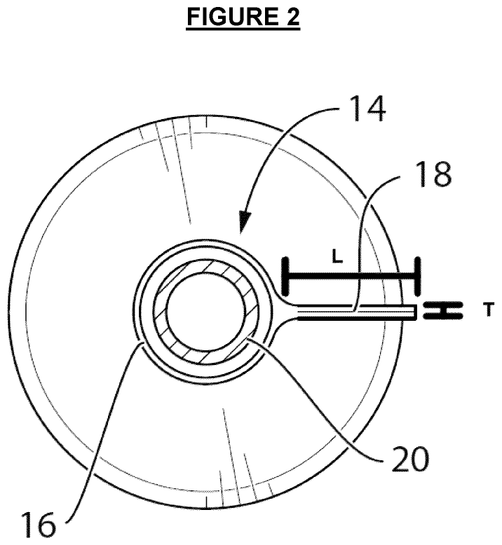

FIG. 2 shows the top of a bottle 20 and the tag 14 engaged with the neck of the bottle. The band 16 engages the neck of the bottle and the label portion 18 extends outwardly and away from the bottle neck 12. The label portion 18 is defined by a length “L” and a thickness “T”.

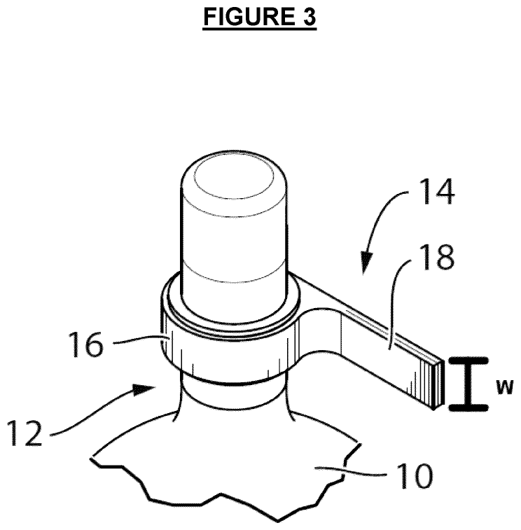

FIG. 3 shows another embodiment of a tag of the disclosure and shows a bottle 10 having a neck 12 in which a tag 14 of the disclosure has been placed around the neck 12. The tag 14 has a band 16 and a label portion 18 which extends outwardly from the bottle neck, and the label portion is offset from the band.

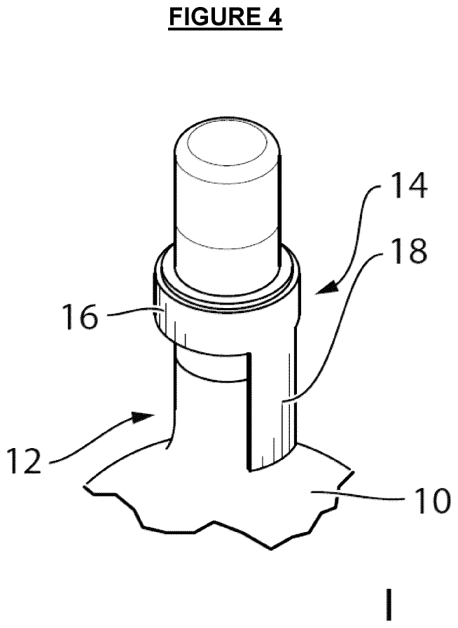

FIG. 4 shows another embodiment of a tag of the disclosure and shows a bottle 10 having a neck 12 in which a tag 14 of the disclosure has been placed around the neck 12. The tag 14 has a circular band 16 and a label portion 18 which extends downwardly and along the axis of the bottle neck. In one embodiment, the label portion 18 is operable to move from a position which is substantially perpendicular to the neck of the bottle, to a position as shown in FIG. 4, which is generally parallel to the vertical axis of the neck of the bottle.

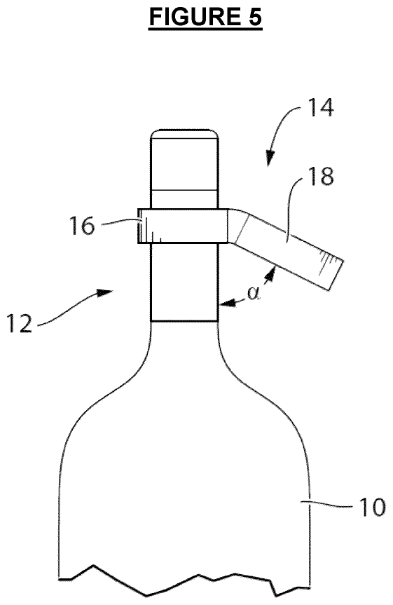

FIG. 5 shows another embodiment of a tag of the disclosure and shows a bottle 10 having a neck 12 in which a tag 14 of the disclosure has been placed around the neck 12. The tag 14 has a band 16 and a label portion 18 which extends outwardly from the bottle neck, at an angle α with respect to the vertical axis of the neck of the bottle. In one embodiment, the angle α may be perpendicular (90°) or substantially perpendicular with respect to the bottle neck. In another embodiment, the angle α may also be less than 90°, for example between 45° and 90°, such that the label portion extends outwardly from the bottle neck at an angle, respective to the vertical axis of the bottle neck. In another embodiment, the angle α may also be greater than 90°, for example between 90° and 135°, such that the label portion extends outwardly from the bottle neck at an angle, respective to the vertical axis of the bottle neck.

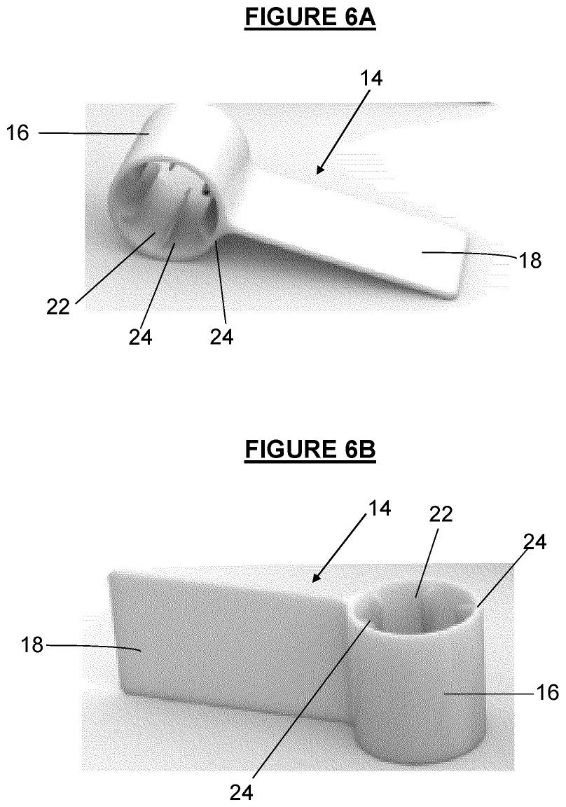

FIGS. 6A and 6B shows another embodiment of a tag of the disclosure in which the band of the tag comprises flexible vanes (or fingers). FIG. 6 shows a bottle tag 14 which has a band 16 and a label portion 18. The band 16 has an interior surface 22 which has flexible vanes 24 on the surface which engage the neck of a bottle.

Although the disclosure has been described in conjunction with specific embodiments thereof, if is evident that many alternatives, modifications and variations will be apparent to those skilled in the art. Accordingly, it is intended to embrace all such alternatives, modifications and variations that fall within the spirit and broad scope of the appended claims. In addition, citation or identification of any reference in this application shall not be construed as an admission that such reference is available as prior art to the present disclosure.

While the present disclosure has been described with reference to what are presently considered to be the preferred examples, it is to be understood that the application is not limited to the examples described herein. To the contrary, the present disclosure is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

1.-31. (canceled)

32. A tag for a bottle having a neck, comprising:
i) a band which frictionally engages the whole circumference of the neck of the bottle;
ii) a label portion which extends outwardly from the band at an angle of about 70° to about 120° with respect to the vertical axis of the bottle neck,
wherein the bottle is a wine bottle, liquor bottle, beer bottle or cooking oil bottle, and
wherein the band frictionally engages the neck of the bottle to maintain its placement around the neck.

33. The tag according to claim 32, wherein the band is circular for positioning around the neck of the bottle.

34. The tag according to claim 33, wherein the circular band is operable to frictionally engage the neck of the bottle.

35. The tag according to claim 32, wherein the band is an elastically deformable band.

36. The tag according to claim 35, wherein the neck of the bottle has an exterior surface, and wherein the elastically deformable band can be positioned over the neck and biases against the exterior surface.

37. (canceled)

38. The tag according to claim 37, wherein the label portion extends outwardly from the band at an angle which is substantially perpendicular with respect to the vertical axis of the bottle neck.

39.-40. (canceled)

41. The tag according to claim 32, wherein the label portion extends generally horizontally from the vertical axis of the neck bottle, wherein when the bottle is upright, a person can read the label.

42. The tag according to claim 32, wherein the band has an interior surface and an exterior surface, and the interior surface is flexible to be positioned over the neck of the bottle.

43. The tag according to claim 42, wherein the interior surface is flexible to frictionally engage the neck of the bottle.

44.-52. (canceled)

53. The tag according to claim 32, wherein the label portion is defined by a length which extends outwardly and generally perpendicular to the vertical axis of the neck of the bottle

54.-58. (canceled)

59. A tag for a bottle having a neck and a shoulder, comprising:
i) a band which frictionally engages the whole circumference of the neck of the bottle;
ii) a label portion which extends outwardly from the band at an angle of about 45° to about 135° with respect to the vertical axis of the bottle neck, and wherein the label portion does not touch the shoulder of the bottle;
wherein the bottle is a wine bottle, liquor bottle, beer bottle or cooking oil bottle, and
wherein the band frictionally engages the neck of the bottle to maintain its placement around the neck.

60. The tag according to claim 59, wherein the band is circular for positioning around the neck of the bottle.

61. The tag according to claim 59 or 60, wherein the band is an elastically deformable band.

62. (canceled)

63. The tag according to claim 59, wherein label portion extends outwardly from the band at an angle of about 70° to about 120° with respect to the vertical axis of the bottle neck.

64. The tag according to claim 63, wherein the label portion extends outwardly from the band at an angle which is substantially perpendicular with respect to the vertical axis of the bottle neck.

65. The tag according to claim 64, wherein the label portion extends outwardly from the band at an angle which is perpendicular with respect to the vertical axis of the bottle neck.

66. The tag according to claim 59, wherein the label portion is made of a generally resilient material that extends outwardly, generally perpendicular to the vertical axis of the neck of the bottle.

67. The tag according to claim 66, wherein the label portion extends generally horizontally from the vertical axis of the neck bottle, wherein when the bottle is upright, a person can read the label.

68. The tag according to claim 59, wherein the band has an interior surface and an exterior surface, and the interior surface is flexible to be positioned over the neck of the bottle.

69. The tag according to claim 68, wherein the interior surface is flexible to frictionally engage the neck of the bottle.

70.-84. (canceled)
